(19) United States
(12) Patent Application Publication
(10) Pub. No.: US 2013/0311970 A1
(43) Pub. Date: Nov. 21, 2013

(54) Creation and Manipulation of Document Hierarchy Using Layers Represented on an Interface

(71) Applicant: Jonathan M. Duran, Benicia, CA (US)

(72) Inventor: Jonathan M. Duran, Benicia, CA (US)

(73) Assignee: Motorola Mobility, Inc., Libertyville, IL (US)

(21) Appl. No.: 13/472,682

(22) Filed: May 16, 2012

(51) Int. Cl. G06F 9/44

(52) U.S. Cl. 717/106; 717/110

(57) ABSTRACT

In one embodiment, a method determines software code created for an animation of a plurality of elements. The software code represents the plurality of elements in a first hierarchy. A plurality of layers are displayed on an interface to represent the plurality of elements. The plurality of layers are displayed in a second hierarchy on the interface corresponding to the first hierarchy. The method generates linking information to link the plurality of layers to the plurality of elements in the software code. When a change is detected in the second hierarchy for the plurality of layers on the interface, the method causes a corresponding change in the software code to change the first hierarchy for the plurality of elements based on the change in the second hierarchy for the plurality of layers where the corresponding change is performed using the linking information.

### BACKGROUND

To create an animation, a user could manually write software code in hypertext transfer markup language (HTML) code to create the animation. Manually writing code, however, may be tedious. Authoring applications are provided to allow a user to visually create animations in a user interface. These authoring applications create corresponding HTML code for the animation.

The animation may animate multiple elements and a document object model (DOM) describes a structure of the elements, such as a hierarchy of the elements. A web browser uses the DOM to render a document, such as a web page. When the web page is rendered in the browser, the browser parses the HTML code in the DOM, and uses the hierarchy to construct internal structures that are used to display the web page in the browser. For example, a browser uses the hierarchy to determine an order of displaying the elements.

If a user wants to manipulate the hierarchy of the DOM, the user can access the HTML code and cut-and-paste an element in the HTML code to another position in the HTML code. This is somewhat tedious as the user needs to identify the element in the HTML code and then manually cut-and-paste the element to another position in the HTML code to change the position of the element in the DOM hierarchy.

### BRIEF DESCRIPTION OF THE DRAWINGS

FIG. 1 depicts an example of a computing device for creating animations according to one embodiment.

FIG. 2 depicts a more detailed example of an interface according to one embodiment.

FIG. 3 depicts an example of software code that is created for elements in FIG. 2 according to one embodiment.

FIG. 4 depicts simplified flowchart of a method for creating layers according to one embodiment.

FIG. 5 depicts an example of the interface where layers have been moved to different positions in the hierarchy according to one embodiment.

FIG. 6 depicts an example of the changed software code according to one embodiment.

FIG. 7 depicts a simplified flowchart for manipulating software code based on changes of layers in the interface according to one embodiment.

FIG. 8 depicts a more detailed example of an authoring application according to one embodiment.

### DETAILED DESCRIPTION

Described herein are techniques for an animation system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

In one embodiment, a method determines software code created for an animation of a plurality of elements. The software code represents the plurality of elements in a first hierarchy. A plurality of layers are displayed on an interface to represent the plurality of elements. The plurality of layers are displayed in a second hierarchy on the interface corresponding to the first hierarchy. The method generates linking information to link the plurality of layers to the plurality of elements in the software code. When a change is detected in the second hierarchy for the plurality of layers on the interface, the method causes a corresponding change in the software code to change the first hierarchy for the plurality of elements based on the change in the second hierarchy for the plurality of layers where the corresponding change is performed using the linking information.

In one embodiment, a non-transitory computer-readable storage medium is provided that contains instructions for controlling a computer system to be operable for: determining software code created for an animation of a plurality of elements, the software code representing the plurality of elements in a first hierarchy; causing display of a plurality of layers on an interface to represent the plurality of elements, the plurality of layers displayed in a second hierarchy on the interface corresponding to the first hierarchy; generating linking information to link the plurality of layers to the plurality of elements in the software code; detecting a change in the second hierarchy for the plurality of layers on the interface; and causing a corresponding change in the software code to change the first hierarchy for the plurality of elements based on the change in the second hierarchy for the plurality of layers, the corresponding change performed using the linking information.

In one embodiment, an apparatus is provided comprising: one or more computer processors; and a computer-readable storage medium comprising instructions for controlling the one or more computer processors to be operable to: determining software code created for an animation of a plurality of elements, the software code representing the plurality of elements in a first hierarchy; causing display of a plurality of layers on an interface to represent the plurality of elements, the plurality of layers displayed in a second hierarchy on the interface corresponding to the first hierarchy; generating linking information to link the plurality of layers to the plurality of elements in the software code; detecting a change in the second hierarchy for the plurality of layers on the interface; and causing a corresponding change in the software code to change the first hierarchy for the plurality of elements based on the change in the second hierarchy for the plurality of layers, the corresponding change performed using the linking information.

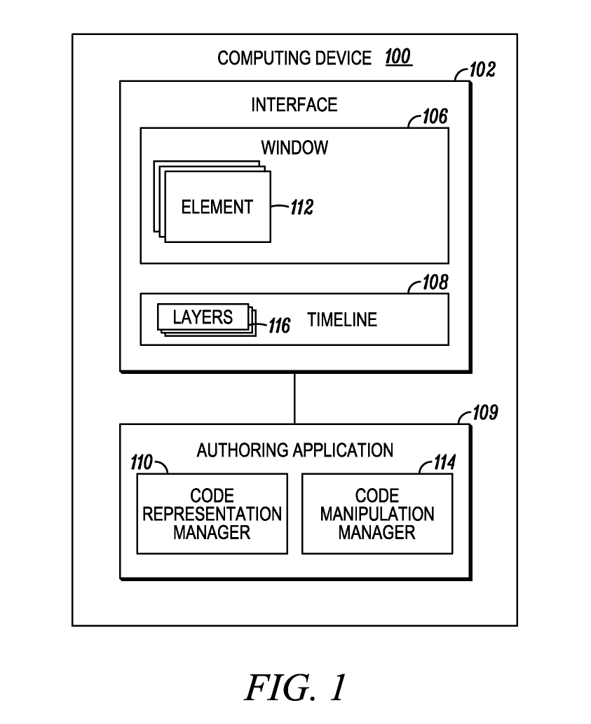

FIG. 1 depicts an example of a computing device 100 for creating animations according to one embodiment. Computing device 100 includes an interface 102 and an authoring application 109 that are used to visually create an animation. Authoring application 109 may be included in computing device 100 or the functions of authoring application 109 may be distributed, such as on a server (not shown) communicating with computing device 100.

Elements 112 may be created in an animation window 106. Elements 112 may be various shapes, text, or other objects that can be animated. A user may then use authoring application 109 to create an animation by setting properties of an element 112 and selecting a time on a timeline 108. The animation is created by manipulating different properties of elements 112. For example, the position of element 112 may be changed in the animation. In other examples, the color, the shape, or other properties, are changed to create the animation.

As will be described in more detail below, when an element 112 is created in window 106, corresponding software code is created. The software code that is created may be hypertext transfer markup language (HTML) code, but other software languages may be used. The software code may also be included in a document object model (DOM), which represents elements 112 in a hierarchy. Also, when elements 112 are created in window 106, a corresponding layer 116 in interface 102 is created. Layers 116 represent the hierarchy of elements 112 in the software code (e.g., HTML code) that is created for the animation. In one embodiment, each element 112 is associated with a single layer 116. Also, layers 116 are displayed in timeline 108; however, layers 116 may be displayed in other areas of interface 102.

In one embodiment, to create layers 116, a code representation manager 110 scans the created software code and displays a layer 116 in interface 102 in a corresponding hierarchy that corresponds to the hierarchy of elements 112 in the software code. For example, if three elements 112 were created in window 106 and are in a certain hierarchy in the DOM, three layers 116 are created and are displayed in a corresponding hierarchy in interface 102.

A browser or other application uses the hierarchy of the DOM to determine the visual order that elements 112 will be stacked in when the browser displays a page and plays the animation. For example, if elements 112 are overlapping, the element 112 added last to the DOM will appear on top of the other elements 112. Moving elements 112 around in the hierarchy at any level changes the bottom-up stacking order of elements 112. This is used for visually designing animations, such as a scene that has a background, which should always appear at the back.

Particular embodiments allow changes to the hierarchy of the DOM via interface 102. For example, a code manipulation manager 114 allows a user to manipulate the position of layers 116 on interface 102, which automatically causes a corresponding change in the software code. For example, if a layer 116 is moved to a different position in the hierarchy displayed in interface 102, the software code for a corresponding element 112 is changed to move the corresponding element to a different position in the hierarchy of the DOM. In one example, objects in different levels of the hierarchy cannot be moved to another level of the hierarchy. That is, only layers 116 in the same level of the hierarchy can be moved in interface 102. This is due to elements 112 being part of an animation that is created using timeline 108 and movement between levels of the hierarchy is not allowed in creating the animation. Using timeline 108, the functionality of the timeline is to create animations. Thus, given the restrictions with respect to the animations, moving layers 116 to different levels is restricted while using timeline 108 to create animations.

In one example, linking information between elements 112 in the software code and layers 116 is used to perform the change. For example, as layers 116 are created for elements 112, a link between each layer 116 and a corresponding element 112 in the software code is created. In one example, a reference (e.g., an element identifier) from a layer 116 to a corresponding element 112 may be stored in a table. When a layer 116 is moved in interface 102, code manipulation manager 114 determines the corresponding element 112 using the linking information. For example, the linking information may identify the element with an element identifier that is unique to an element 112. The software code is then parsed to determine the element using the element identifier. A position of the element in the DOM may then be changed in the software code based on the change of the layer 116 in the hierarchy displayed in interface 102.

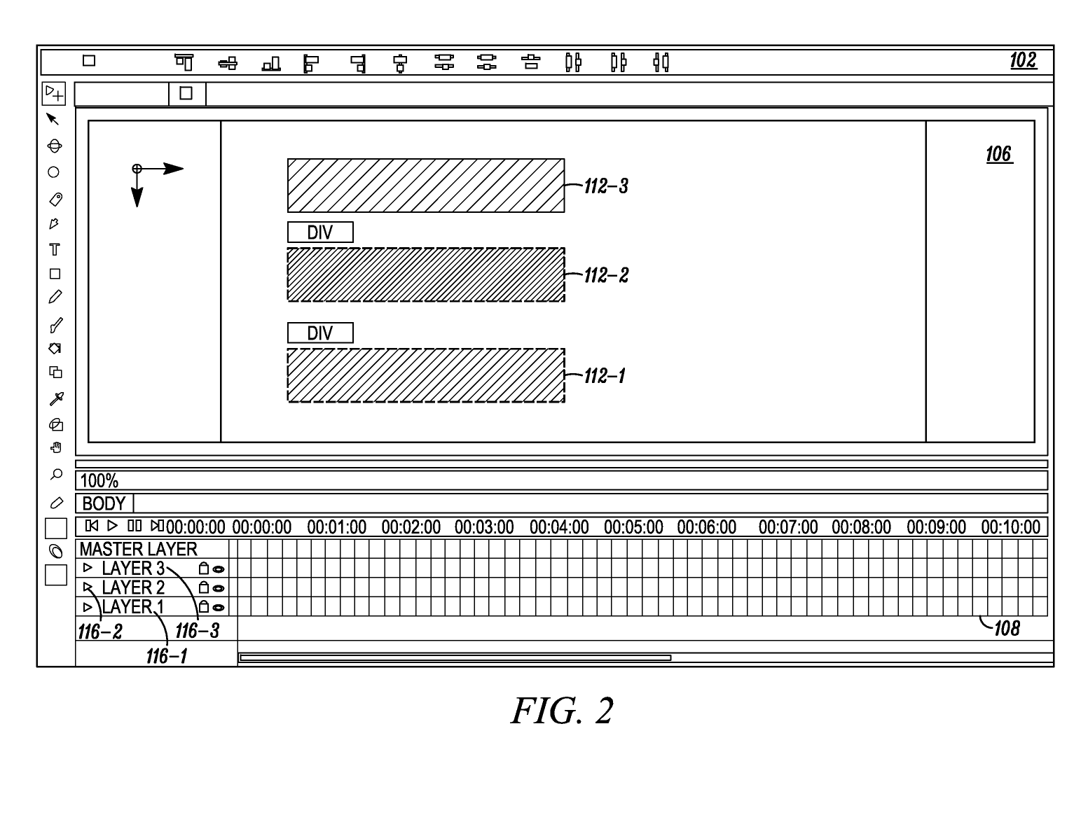

FIG. 2 depicts a more detailed example of interface 102 according to one embodiment. As shown, three elements 112-1, 112-2, and 112-3 have been created in window 106. Additionally, corresponding layers 116-1, 116-2, and 116-3 have been created. In one embodiment, layer 116-1 corresponds to element 112-1, layer 116-2 corresponds to element 112-2, and layer 116-3 corresponds to element 112-3. The hierarchy in a bottom up stacking order is elements 112-3, 112-2, and 112-1 (i.e., element 112-3 is behind element 112-2, and element 112-2 is behind element 112-1). Layers 116 show the bottom up stacking order by putting layer 116-3 above layer 116-2, and layer 116-2 above layer 116-1. Also, in this case, layer 1, layer 2, and layer 3 are included under a master layer. The master layer may be a root node in the hierarchy. Also, layer 1, layer 2, and layer 3 are child nodes of the master layer. Although not shown, any of layers 1-3 may also have children nodes and so on.

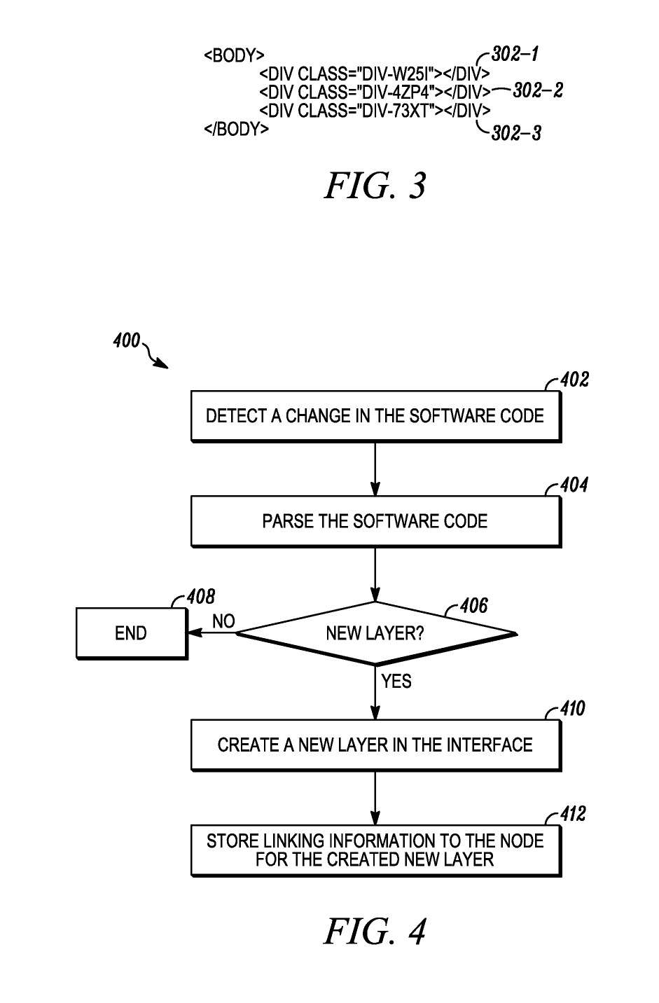

FIG. 3 depicts an example of software code that is created for elements 112-1-112-3 for FIG. 2 according to one embodiment. The software code may be a Document Object Model of HTML code that is created for an animation of elements 112 and is arranged in a hierarchy. For example, elements 112 that are shown above another element 112 are considered below the another element in the bottom up stacking order. Each element 112 will be referred to as a “node”. The node may include any software code that is created for the animation for an element 112. For example, node 302-1 corresponds to element 112-3, node 302-2 corresponds to element 112-2, and node 302-3 corresponds to element 112-1. Each node 302 may describe the corresponding element 112. Also, each node 302 is linked to a layer 116, such as a first node 302-1 corresponds to layer 116-3, a second node 302-2 corresponds to a layer 116-2, and a third node 302-3 corresponds to layer 116-1.

As shown, nodes 302 are arranged in a hierarchy. For example, nodes 302 may be in the same level of the hierarchy. However, the order of nodes 302 in the hierarchy is node 302-1, node 302-2, and node 302-3, which represents an order of stacking in which a browser may display corresponding elements 112-1-112-3. This order is also represented visually in interface 102. For example, layer 116-3 is displayed above layer 116-2, and layer 116-2 is displayed above layer 116-1 in interface 102. This allows a user to visually view the hierarchy of the Document Object Model via layers 116 in interface 102.

Different ways of creating layers 116 may be used. For example, FIG. 4 depicts simplified flowchart 400 of a method for creating layers 116 according to one embodiment. At 402, code representation manager 110 detects a change in the software code. For example, a user may have added an element 112 in window 106, which creates a corresponding node 302 in the software code. Code representation manager 110 may detect that the software code has been changed or an indication may be sent to code representation manager 110 indicating that the change has been made.

At 404, code representation manager 110 parses the software code. In one embodiment, for every change that is made, code representation manager 110 may parse the entire software code. In other embodiments, code representation manager 110 may only parse portions of the software code, such as portions including the changes to the software code. For example, code representation manager 110 calculates the changes, such as code representation manager 110 determines a node 302 that has been added to the software code.

At 406, code representation manager 110 determines if a new layer 116 has been encountered while parsing the software code. For example, if the entire software code is being parsed, if a node 302 is encountered that is new, it is determined that a new layer 116 should be created. If no new layers 116 need to be created, the process ends at 408.

At 410, if a new layer 116 is to be created, code representation manager 110 creates a new layer 116 in interface 102. For example, layer 116 is created in a position in the hierarchy in interface 102 based on a position in the hierarchy of a corresponding node 302 in the software code.

At 412, code representation manager 110 stores linking information to node 302 for the created new layer 116. For example, an element identifier is stored and associated with layer 116.

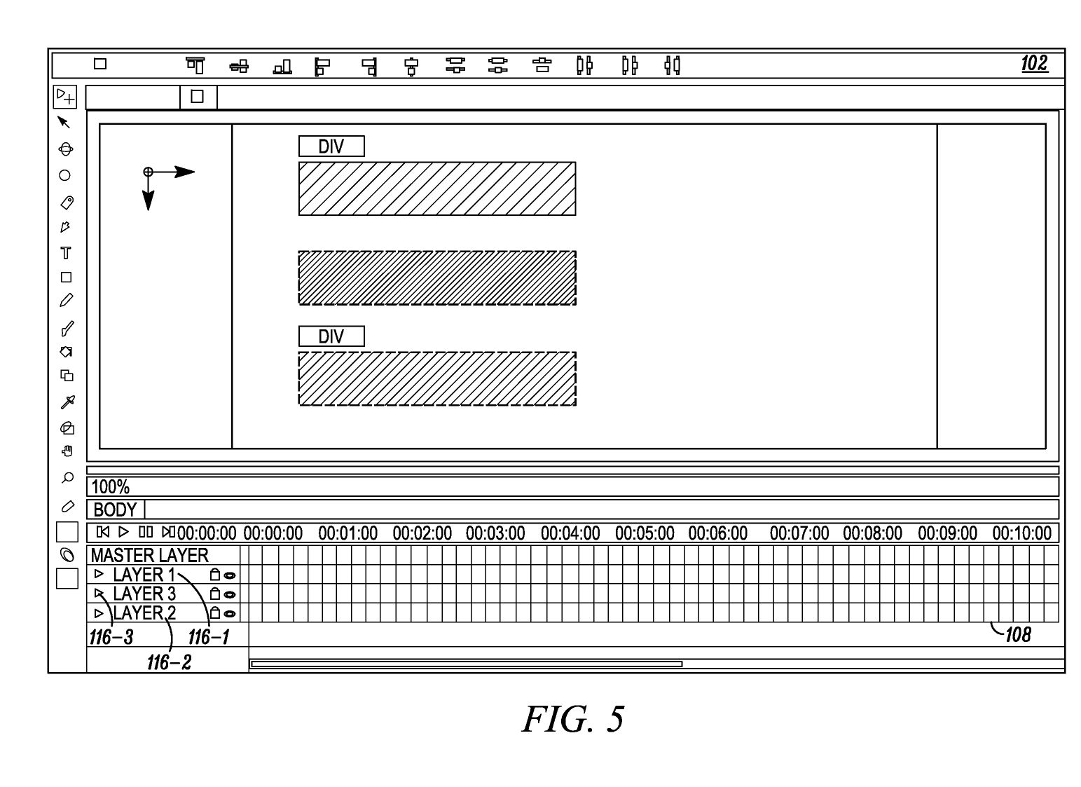

A user may manipulate the positioning of layers 116 on interface 102. For example, the position of layers 116 in the hierarchy represented in interface 102 may be changed by a user selecting a layer 116 and moving the layer to a different position in the hierarchy (e.g., drag and drop). Other methods may be used to move the layers also. As shown in FIG. 5, all layers 116 have been moved to different positions in the hierarchy shown in interface 102. The positioning is now layer 116-1 above layer 116-3, and layer 116-3 above layer 116-2 in the hierarchy. This changes the bottom up stacking order with layer 116-1 is on the bottom. It is noted that layers 116 are still in the same level of the hierarchy, but the ordering has been changed.

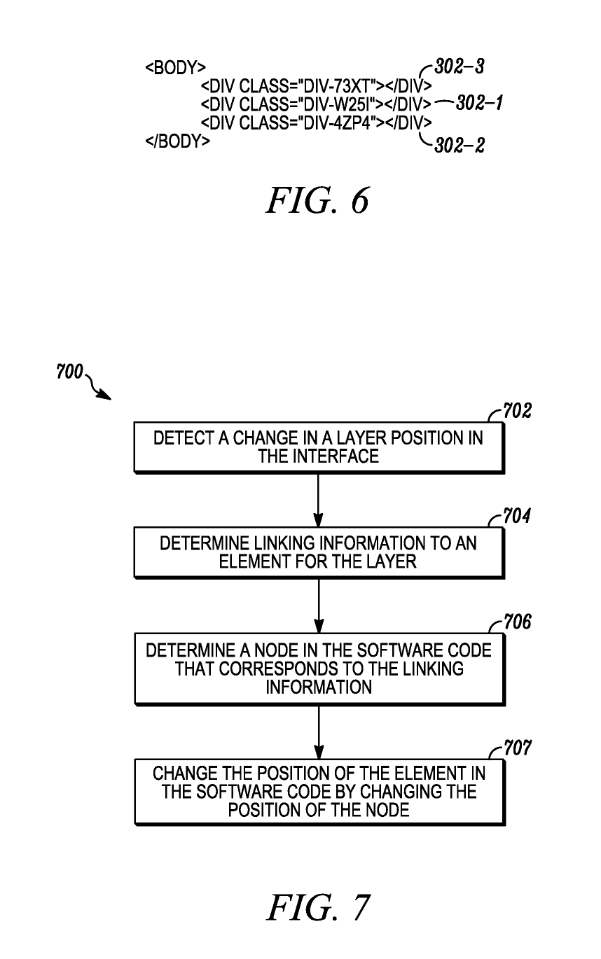

In response to the change in the positioning of layers 116 in the hierarchy displayed in interface 102, code manipulation manager 114 changes a position of nodes 302 in the corresponding software code. For example, FIG. 6 depicts an example of the changed software code according to one embodiment. As shown, the ordering of nodes 302 in the hierarchy of the DOM has been changed to node 302-3, node 302-1, and node 302-2, which corresponds to an order of element 112-1, element 112-3, and element 112-2. Accordingly, an automatic change of positions of nodes 302 that correspond to elements 112 is performed in the software code when a change to layers 116 is performed in interface 102.

FIG. 7 depicts a simplified flowchart 700 for manipulating software code based on changes of layers 116 in interface 102 according to one embodiment. At 702, code manipulation manager 114 detects a change in a layer position in interface 102. For example, a layer 116 may be changed to a different position in the hierarchy displayed on interface 102. Also, a number of layers 116 may change position. In one example, code manipulation manager 114 scans the entire hierarchy on interface 102 to determine any changes. In other embodiments, only changes in positions are determined without scanning the whole hierarchy.

At 704, code manipulation manager 114 determines linking information to an element 112 for layer 116. For example, an element identifier is determined. At 706, code manipulation manager 114 then determines a node 302 in the software code that corresponds to the linking information. At 708, code manipulation manager 114 changes the position of element 112 in the software code by changing the position of the corresponding node 302. The change in position of node 302 corresponds to the position change of layer 116 in interface 102.

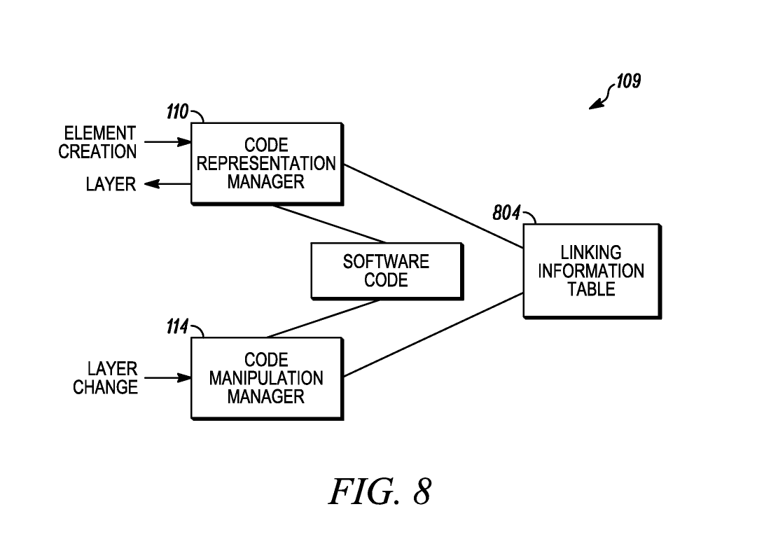

FIG. 8 depicts a more detailed example of authoring application 109 according to one embodiment. Code representation manager 110 receives an indication that an element 112 has been created in window 106. For example, code representation manager 110 detects the placing of an element 112 in window 106 and scans the software code being created.

Code representation manager 110 then creates a layer 116 in interface 102. Layer 116 is positioned in the hierarchy based on the position of element 112 in the corresponding software code. For example, if element 112 is the third element placed in interface 102, it is represented in the third position in interface 102 among layers 116.

Code representation manager 110 also stores linking information in a linking information table 804. The linking information links a layer 116 that is created by code representation manager 110 to the node 302 in the software code.

Code manipulation manager 114 detects a change in a position of a layer 116 in a hierarchy displayed in interface 102. Code manipulation manager 114 then determines linking information for layer 116 from linking information table 804. Using the linking information, code manipulation manager 114 determines a node 302 in the software code associated with an element 112 that corresponds to the changed layer 116. Code manipulation manager 114 then changes a position of node 302 in the hierarchy of software code 802.

Accordingly, a mapping between layers 116 and elements 112 represented in the software code is provided. This allows a user to manipulate a position of layers 116 on interface 102 and have the change automatically performed in the software code that was generated for the animation.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining software code created for an animation of a plurality of elements, the software code representing the plurality of elements in a first hierarchy;
causing display of a plurality of layers on an interface to represent the plurality of elements, the plurality of layers displayed in a second hierarchy on the interface corresponding to the first hierarchy;
generating linking information to link the plurality of layers to the plurality of elements in the software code;
detecting, by a computing device, a change in the second hierarchy for the plurality of layers on the interface; and
causing, by the computing device, a corresponding change in the software code to change the first hierarchy for the plurality of elements based on the change in the second hierarchy for the plurality of layers, the corresponding change performed using the linking information.

2. The method of claim 1, further comprising:
detecting the plurality of elements being created on the interface; and
automatically generating the software code for the plurality of elements based on the plurality of elements being created.

3. The method of claim 1, further comprising:
scanning the software code to determine a position in the first hierarchy for an element in the plurality of elements that was created on the interface; and
causing display of a layer in the plurality of layers for the element, the element being displayed in a position in the second hierarchy corresponding to a position of the element in the first hierarchy.

4. The method of claim 1, wherein generating the linking information comprises:
determining linking information for each of the plurality of elements; and
storing, for each of the plurality of layers, an identifier for one of the plurality of elements.

5. The method of claim 4, wherein causing the corresponding change comprises:
determining a layer in which a position is moved in the second hierarchy on the interface;
determining an identifier for an element in the software code that corresponds to the layer;
identifying the element in the software code using the element identifier; and
adjusting a position of the element in the first hierarchy of the software code to correspond to the position that is moved for the layer in the second hierarchy.

6. The method of claim 5, wherein the layer is moved via a user input moving the position of the layer on the interface.

7. The method of claim 1, wherein each layer in the plurality of layers is associated with a single element in the plurality of elements.

8. The method of claim 1, wherein changes in the second hierarchy are only allowed within a single level of the second hierarchy.

9. A non-transitory computer-readable storage medium containing instructions for controlling a computer system to be operable for:
determining software code created for an animation of a plurality of elements, the software code representing the plurality of elements in a first hierarchy;
causing display of a plurality of layers on an interface to represent the plurality of elements, the plurality of layers displayed in a second hierarchy on the interface corresponding to the first hierarchy;
generating linking information to link the plurality of layers to the plurality of elements in the software code;
detecting a change in the second hierarchy for the plurality of layers on the interface; and
causing a corresponding change in the software code to change the first hierarchy for the plurality of elements based on the change in the second hierarchy for the plurality of layers, the corresponding change performed using the linking information.

10. The non-transitory computer-readable storage medium of claim 9, further operable for:
detecting the plurality of elements being created on the interface; and
automatically generating the software code for the plurality of elements based on the plurality of elements being created.

11. The non-transitory computer-readable storage medium of claim 9, further operable for:
scanning the software code to determine a position in the first hierarchy for an element in the plurality of elements that was created on the interface; and
causing display of a layer in the plurality of layers for the element, the element being displayed in a position in the second hierarchy corresponding to a position of the element in the first hierarchy.

12. The non-transitory computer-readable storage medium of claim 9, wherein generating the linking information comprises:
determining linking information for each of the plurality of elements; and
storing, for each of the plurality of layers, an identifier for one of the plurality of elements.

13. The non-transitory computer-readable storage medium of claim 12, wherein causing the corresponding change comprises:
determining a layer in which a position is moved in the second hierarchy on the interface;
determining an identifier for an element in the software code that corresponds to the layer;
identifying the element in the software code using the element identifier; and
adjusting a position of the element in the first hierarchy of the software code to correspond to the position that is moved for the layer in the second hierarchy.

14. The non-transitory computer-readable storage medium of claim 13, wherein the layer is moved via a user input moving the position of the layer on the interface.

15. The non-transitory computer-readable storage medium of claim 9, wherein the master duration is associated with a total animation including all animations of elements in the plurality of elements.

16. The non-transitory computer-readable storage medium of claim 9, wherein each layer in the plurality of layers is associated with a single element in the plurality of elements.

17. The non-transitory computer-readable storage medium of claim 9, wherein changes in the second hierarchy are only allowed within a single level of the second hierarchy.

18. An apparatus comprising:
one or more computer processors; and
a computer-readable storage medium comprising instructions for controlling the one or more computer processors to be operable to:
determining software code created for an animation of a plurality of elements, the software code representing the plurality of elements in a first hierarchy;
causing display of a plurality of layers on an interface to represent the plurality of elements, the plurality of layers displayed in a second hierarchy on the interface corresponding to the first hierarchy;
generating linking information to link the plurality of layers to the plurality of elements in the software code;
detecting a change in the second hierarchy for the plurality of layers on the interface; and
causing a corresponding change in the software code to change the first hierarchy for the plurality of elements based on the change in the second hierarchy for the plurality of layers, the corresponding change performed using the linking information.

19. The apparatus of claim 18, further operable for:
detecting the plurality of elements being created on the interface; and
automatically generating the software code for the plurality of elements based on the plurality of elements being created.

20. The apparatus of claim 18, further operable for:
scanning the software code to determine a position in the first hierarchy for an element in the plurality of elements that was created on the interface; and
causing display of a layer in the plurality of layers for the element, the element being displayed in a position in the second hierarchy corresponding to a position of the element in the first hierarchy.
